(19) United States
(12) Patent Application Publication
(10) Pub. No.: US 2024/0142105 A1
(43) Pub. Date: May 2, 2024

(54) DETACHABLE AND FOLDABLE WINDSCREEN DEVICE FOR GAS CANISTERS, STOVES, AND COOKING DEVICES AND APPARATUSES

(71) Applicant: Lawrence I. Simmer, Thousand Oaks, CA (US)

(72) Inventor: Lawrence I. Simmer, Thousand Oaks, CA (US)

(21) Appl. No.: 17/978,207

(22) Filed: Oct. 31, 2022

(51) Int. Cl. F24C 1/16; F24C 3/14

(52) U.S. Cl. CPC F24C 1/16; F24C 3/14

(57) ABSTRACT

The present invention is a detachable and foldable windscreen device dimensioned and configured for being attached or secured to gas canisters, stoves, and cooking devices and apparatuses of various sizes. When not in use, the device may be detached or unsecured from the gas canisters, stoves, and cooking devices and apparatuses and then folded into a smaller form or version for stowage and/or transport. In a non-limiting embodiment, the device is dimensioned and configured for being attached or secured to a mini or portable size gas canister. The device preferably includes a windscreen; an extension; and a securing element or device for attaching the windscreen to a mini or portable size gas canister via the extension. As a non-limiting example, the windscreen may be comprised of two or more portions or sections to allow the windscreen device to be foldable into a smaller form or version for stowage and/or transport.

### BACKGROUND OF THE INVENTION

### Field of the Invention

The present invention relates generally to windscreen and wind deflecting devices for gas canisters, stoves, and cooking devices and apparatuses. More particularly, the present invention is a detachable and foldable windscreen device for being attached or secured to gas canisters, stoves, and cooking devices and apparatuses to reduce the effects of wind and weather elements.

### Description of the Related Art

Windscreen and wind deflecting devices for gas canisters, stoves, and cooking devices and apparatuses are known in the art.

The present invention overcomes one or more of the shortcomings of windscreen and wind deflecting devices for gas canisters, stoves, and cooking devices and apparatuses. The Applicant is unaware of inventions or patent documents, taken either singly or in combination, which are seen to describe the present invention as claimed.

One advantage of the detachable and foldable windscreen device is that it can be dimensioned and configured for being attached or secured to reduced, mini, or portable size gas canisters, stoves, and cooking devices and apparatuses to reduce the effects of wind and weather elements.

Another advantage of the detachable and foldable windscreen device is that it can be dimensioned and configured for being attached or secured to conventional or regular size gas canisters, stoves, and cooking devices and apparatuses to reduce the effects of wind and weather elements.

A further advantage of the detachable and foldable windscreen device is that it can be dimensioned and configured and/or foldable to be easily transportable for users doing outdoor activities, such as, but not limited to, camping, backpacking, hiking, a picnic, a cookout, etc., with reduced, mini, or portable size gas canisters, stoves, and cooking devices and apparatuses to reduce the effects of wind and weather elements.

An additional advantage of the detachable and foldable windscreen device is that it is detachable from gas canisters, stoves, and cooking devices and apparatuses when not in use.

Another advantage of the detachable and foldable windscreen device is that it is foldable into a smaller form or version for stowage and/or transport when not in use.

A further advantage of the detachable and foldable windscreen device is that it helps to retain some, a lot or much of the energy of the flame by blocking the effects of wind and weather elements. Thus, cooking time is reduced and the amount of fuel used or consumed is lessened.

An additional advantage of the detachable and foldable windscreen device is that it is an inexpensive device or method for being attached or secured to gas canisters, stoves, and cooking devices and apparatuses to reduce the effects of wind and weather elements.

### SUMMARY OF THE INVENTION

The present invention is a detachable and foldable windscreen device dimensioned and configured for being attached or secured to gas canisters, stoves, and cooking devices and apparatuses of various sizes (such as, but not limited to, conventional, regular, reduced, mini, or portable), particularly mini and portable sizes, to reduce the effects of wind and weather elements. When not in use, the detachable and foldable windscreen device may be detached or unsecured from the gas canisters, stoves, and cooking devices and apparatuses and then folded into a smaller form or version for stowage and/or transport.

In a non-limiting embodiment, the detachable and foldable windscreen device is dimensioned and configured for being attached or secured to a mini or portable size gas canister. The detachable and foldable windscreen device preferably includes a windscreen; an extension; and a securing element or device for attaching the windscreen to a mini or portable size gas canister via the extension. As a non-limiting example, the windscreen may be comprised of two or more portions or sections to allow the windscreen device to be foldable into a smaller form or version for stowage and/or transport. This may be accomplished by including at least one windscreen hinge or windscreen foldable-allowing element. As a non-limiting example, the windscreen device may also be comprised of at least one connection hinge or connection foldable-allowing element, which secures the windscreen and extension to one another, to also allow the windscreen device to be foldable into a smaller form or version for stowage and/or transport.

In another non-limiting embodiment, the detachable and foldable windscreen device is dimensioned and configured for being attached or secured to a mini or portable size gas canister. The detachable and foldable windscreen device preferably includes a windscreen; and a securing element or device for attaching the windscreen to a mini or portable size gas canister. This embodiment does not include the extension of the other embodiment. As a non-limiting example, the windscreen may be comprised of two or more portions or sections to allow the windscreen device to be foldable into a smaller form or version for stowage and/or transport. This can be accomplished by including at least one windscreen hinge or windscreen foldable-allowing element.

### BRIEF DESCRIPTION OF THE DRAWINGS

FIG. 1 is an environmental, perspective, front view of an embodiment of a detachable and foldable windscreen device according to the present invention;

FIG. 2 is an environmental, rear view of the detachable and foldable windscreen device of FIG. 1;

FIG. 3 is an environmental, perspective, right side view of the detachable and foldable windscreen device of FIG. 1; and

FIG. 4 is an environmental, perspective, left side view of the detachable and foldable windscreen device of FIG. 1.

It should be understood that the above-attached figures are not intended to limit the scope of the present invention in any way.

### DETAILED DESCRIPTION OF THE EMBODIMENTS OF THE PRESENT INVENTION

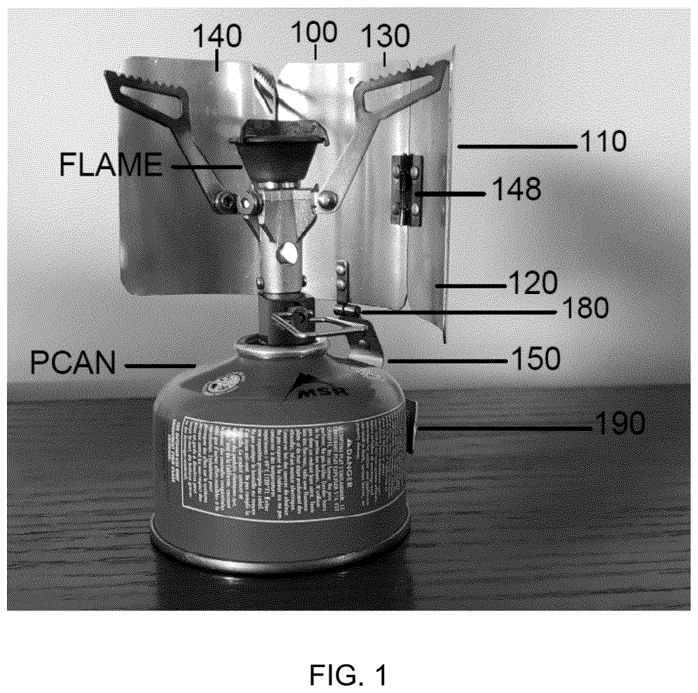

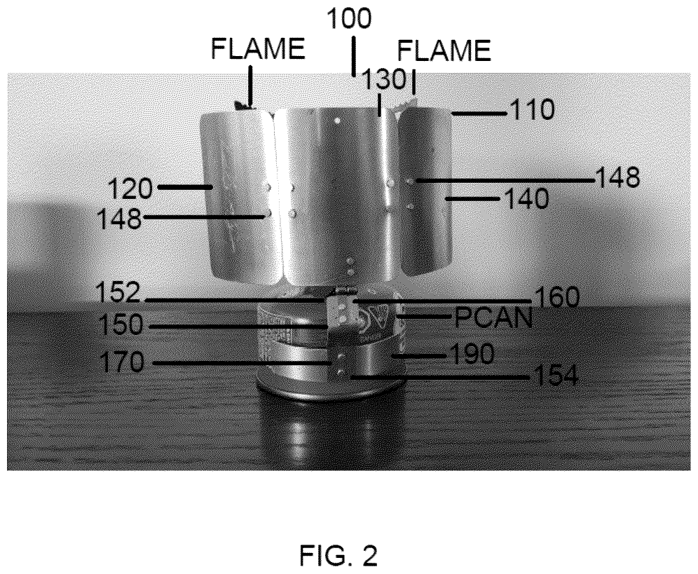

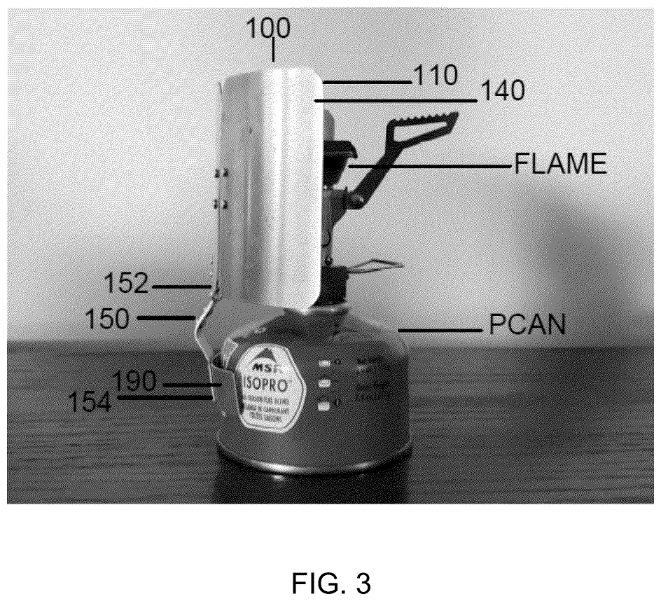

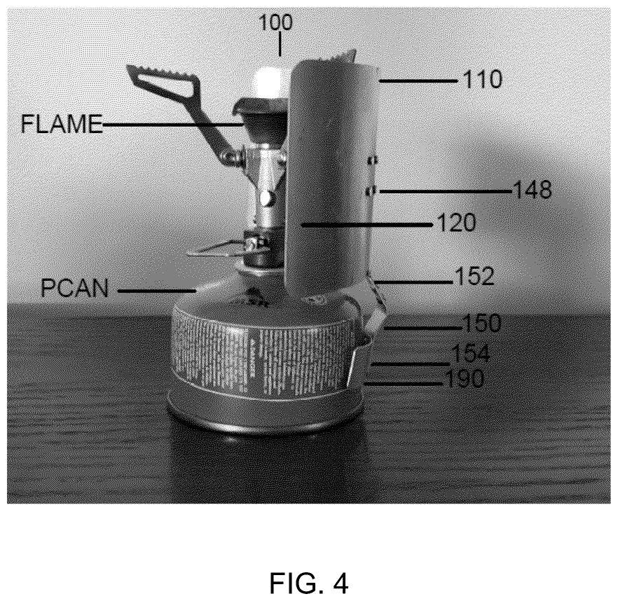

Referring to FIGS. 1-4, the present invention is a detachable and foldable windscreen device 100 for being attached or secured to gas (such as, but not limited to, propane, natural gas, any gas known to one of ordinary skill in the art, and any combination thereof) canisters, stoves, and cooking devices and apparatuses to reduce the effects of wind and weather elements. The detachable and foldable windscreen device can be dimensioned and configured for being attached or secured to conventional or regular size gas canisters, stoves, and cooking devices and apparatuses (such as, but not limited to, barbecue grills, smokers, outdoor grills, outdoor ovens, and any combination thereof) to reduce the effects of wind and weather elements. In addition, the detachable and foldable windscreen device 100 can be dimensioned and configured for being attached or secured to reduced, mini, or portable size gas canisters, stoves, and cooking devices and apparatuses to reduce the effects of wind and weather elements.

In a non-limiting embodiment, the detachable and foldable windscreen device 100 is dimensioned and configured for being attached or secured to a mini or portable size gas canister PCAN. The detachable and foldable windscreen device 100 includes a windscreen 110; an extension (preferably a vertical extension) 150; and a securing element or device 190 for attaching the windscreen 110 to a portable size gas canister PCAN via the vertical extension 150. The detachable and foldable windscreen device 100 may include at least one windscreen hinge or windscreen foldable-allowing element 148 and/or at least one connection hinge or connection foldable-allowing element 180 to allow the windscreen device 100 to be foldable into a smaller form or version for stowage and/or transport.

As a non-limiting example, the windscreen 110 is dimensioned and configured to cover approximately or about 90-degree to approximately or about 270-degree (preferably approximately or about 180-degree) blockage of wind and/or weather elements (such as, but not limited to, rain, hail, sleet, snow, etc.), and not about 360-degree blockage because of possible explosion due to heat reflecting back at a flame-producing device FLAME and/or portable size gas canister PCAN. The windscreen 110 may have a semi-circular, half-circular, curved circular, substantial curved circular, curved rectangular, or substantial curved rectangular configuration. As a non-limiting example, the windscreen 110 may be comprised of a plurality of portions or sections (preferably three portions or sections 120,130,140, but can be two, four or more portions or sections) secured together by at least one (preferably a plurality of) windscreen hinge or windscreen foldable-allowing element 148 to allow the windscreen 110 to be foldable into at least one foldable position as a smaller form or version for stowage and/or transport from at least one expanded position and, alternatively, to be expandable to at least one expanded position from at least one folded position. In addition, the windscreen 110 being comprised of a plurality of portions or sections may help the windscreen 110 flex with the wind and/or weather elements.

As a non-limiting example, the vertical extension 150 has a first end 152 and a second end 154. The first end 152 of the vertical extension 150 is secured to the windscreen 110 by at least one connection hinge or windscreen foldable-allowing element 180 to allow the windscreen device 100 to be foldable into a smaller form or version for stowage and/or transport. In addition, the vertical extension 150 being secured to the windscreen 110 by the at least one connection hinge or windscreen foldable-allowing element 180 may help the windscreen device 100 flex (forwardly toward and, alternatively, rearwardly away from, the portable size gas canister PCAN) with the wind and/or weather elements while the second end 154 of the vertical extension 150 is secured to the securing element or device 190. As a non-limiting example, the vertical extension 150 may have two portions or sections 160,170 where portion or section 170 is generally vertical while portion or section 160 extends forwardly from portion or section 170 toward the flame-producing device FLAME.

The securing element or device 190 detachably attaches or secures the windscreen 110 to the portable size gas canister PCAN, flame-producing device FLAME, or other equivalent device such that the windscreen 110 can sufficiently and effectively reduce the effects of wind and weather elements to allow the flame or fire from the flame-producing device FLAME to work sufficiently and effectively. As a non-limiting example, the securing element or device 190 is at least one magnet or magnetic device 190 that detachably secures the windscreen 110 to the portable size gas canister PCAN. The at least one magnetic device 190 is any magnet device known to one of ordinary skill in the art.

Preferably, each of the windscreen 110, vertical extension 150, securing element or device 190, and hinges 148,190 is made or manufactured of a metal material, aluminum, and any combination thereof. Preferably, each of the windscreen 110, vertical extension 150, securing element or device 190, and hinges 148,190 is made or manufactured of a rustproof or rust-resistant material.

It is to be understood that the present invention is not limited to the embodiments described above or as shown in the attached figures, but encompasses any and all embodiments within the spirit of the invention.

1. A detachable and foldable windscreen device comprising:
a windscreen comprising at least one section, at least one expanded position, and at least one folded position,
wherein said at least one section is foldable by a user from said at least one expanded position to said at least one folded position for stowage and/or transport, and alternatively, are expandable by the user from said at least one folded position to said at least one expanded position for usage; and
at least one securing element for attaching said windscreen to a cooking device in an environment and for detaching said windscreen from the cooking device.

2. The device according to claim 1, wherein said at least one section is a plurality of sections.

3. The device according to claim 1, wherein said at least one securing element is at least one magnet or magnetic device.

4. The device according to claim 1, wherein each of said windscreen and said at least one securing element is made or manufactured of a metal material, aluminum, and any combination thereof.

5. The device according to claim 1, wherein each of said windscreen and said at least one securing element is made or manufactured of a rustproof or rust-resistant material.

6. The device according to claim 1, further comprising at least one windscreen hinge or windscreen foldable-allowing element, wherein said at least one section is a plurality of sections, and wherein said at least one windscreen hinge or windscreen foldable-allowing element engages at least two sections of said plurality of sections.

7. The device according to claim 1, further comprising an extension for securing said windscreen to said at least one securing element.
